(19) United States
(12) Patent Application Publication
(10) Pub. No.: US 2025/0146870 A1
(43) Pub. Date: May 8, 2025

(54) REDUCTION OF OPTICAL INTERFERENCE SIGNALS BY MEANS OF VIBRATORY MOVEMENTS OF OPTICALLY ACTIVE ELEMENTS OF A SPECTROMETER

(71) Applicant: Endress+Hauser Optical Analysis, Inc., Ann Arbor, MI (US)

(72) Inventors: Jürgen Dessecker, Wittlingen (DE); Patrick Ehlers, Mölnlycke (SE); Marc Winter, Gelnhausen (DE); Joseph B. Slater, Dexter, MI (US)

(21) Appl. No.: 18/940,403

(22) Filed: Nov. 7, 2024

(30) Foreign Application Priority Data
Nov. 7, 2023 (DE) 10 2023 130 826.2

(51) Int. Cl. G01J 3/02; G01J 3/433

(52) U.S. Cl. CPC G01J 3/0297; G01J 3/0202; G01J 3/021; G01J 3/4338

(57) ABSTRACT

A spectrometer including: a laser light source, including a tunable diode laser with a coherent laser output, wherein the laser light source is configured to modulate the frequency of the coherent laser output; a photodetector arranged to receive the coherent laser output; at least one optical element arranged between the laser output and the photodetector; and an evaluation unit electrically connected to the photodetector. The laser light source and/or the first optical element is mounted on a movable carrier, wherein the movement of the carrier is oscillatory and changes the path length of the radiation such that interference signals are suppressed, wherein the suppression occurs due to interference between the radiation emitted from the light source and the change in the path length of the beam path due to the movement on the movable carrier.

### CROSS-REFERENCE TO RELATED APPLICATION

The present application is related to and claims the priority benefit of German Patent Application No. 10 2023 130 826.2, filed on Nov. 7, 2023, the entire contents of which are incorporated herein by reference.

### TECHNICAL FIELD

This present disclosure relates generally to the improved detection of gases used, for example, for monitoring the environmental atmosphere, the gases formed in a wastewater treatment plant, in process monitoring, checking and control, in quality assurance in gas production and in industrial processes in which gases are formed and in the transport of gases. The present disclosure relates to improvements in the detection and measurement of gas concentrations and gas emissions based on tunable diode lasers.

### BACKGROUND

It is known that the detection sensitivity of tunable diode laser-wavelength modulation spectroscopy (TDL-WMS) is limited by interference fringes and not by the theoretical limit given by the detector noise. The interference fringes are caused by Fabry-Perot etalons between reflecting or scattering surfaces of optical elements, end faces of glass fibers, and components of multipass cells. A first quantitative analysis of the effects of interference fringes on detection sensitivity was performed by Reid et al. (Reid et al., Optical and quantum electronics, Vol. 17 1985). In their study, the authors estimated that they could improve detection sensitivity by at least a factor of 5 if they could eliminate the interference fringes.

Oscillatory movement with an amplitude and/or frequency changes the path length of the radiation in such a way that interference signals which arise on optical elements as optical interference due to the superposition of rays of different optical path lengths by the partial reflection on at least one optical surface are suppressed, wherein the suppression occurs due to interference between the radiation emitted from the light source and the change in the path length of the beam path due to the movement of the optical surface on the movable carrier. In addition to the optical fringes of optical cavities, any reflection back to the laser changes the laser characteristics. If we can change the back reflections at a frequency much higher than the bandwidth of the measured signal, the effects caused by the back reflection can also be filtered out. The filtered or adjusted signal therefore corresponds more closely to the actual signal than if the suppression is not applied.

### SUMMARY

The object of the present disclosure is to provide a device and the corresponding method which are more robust and simplified than the prior art configured to suppress interference signals due to optical interference by the superposition of rays of different optical path lengths by at least partial reflection on at least one optical surface.

The object is achieved by a spectrometer comprising:
(i) a laser light source configured to generate coherent radiation, comprising a tunable diode laser with a coherent laser output, wherein the coherent laser light source is configured to modulate the frequency of the coherent laser output;
(ii) a photodetector arranged to receive the coherent radiation from the laser output after passage of a path length;
(iii) at least one optical element, for example a first lens or a first mirror, which is arranged along the path length between the laser output and the photodetector; and
(iv) an evaluation unit which is electrically connected to the photodetector configured to receive signals from the photodetector, to analyze them, and to transmit instructions to a controller, which is electrically connected to the evaluation unit, wherein
the laser light source and/or the first optical element is mounted on a movable carrier, wherein the carrier is moved by the drive driven by the controller,
wherein the movement of the carrier is an oscillatory movement with an amplitude and/or frequency and changes the path length of the radiation such that interference signals which arise on the at least one optical element as optical interference due to the superposition of rays of different optical path lengths by the at least partial reflection on at least one optical surface are suppressed, wherein the suppression occurs due to interference between the radiation emitted from the light source and the change in the path length of the beam path due to the movement on the movable carrier.

The procedure of the current disclosure for suppressing interference signals applies a method and a device for mechanical oscillatory movements of at least one optically active element of the spectrometer, which changes the optical path length of the beam.

An advantage of the device is that the at least one optically active element provided for the oscillatory movements may be a mechanical component and not the radiation source, which is susceptible to interference because its power depends on the input current. This means that it is not necessary to design the electrical connection to the laser in such a way that it remains unaffected by the mechanical movement. This is beneficial both for the measurement accuracy and for the long-term stability of the system.

In at least one embodiment, the movable carrier has a rotator, wherein the rotator is rotatable by less than 10°, continuously or stepwise about the x, y or z axis or a combination thereof, and/or a translator, wherein the translator is movable continuously or stepwise along the x, y or z axis or any combination thereof.

In at least one embodiment, the amplitude is a multiple of the laser wavelength, for example, 2 to 10 times the laser wavelength, wherein the amplitude may be 0.5 μm to 50 μm, for example, 1 μm to 10 μm.

In at least one embodiment, the movement of the carrier is temporally sinusoidal, sawtooth-shaped, triangular, or rectangular and/or suppresses interference signals at frequencies between 1 and 200 kHz.

In at least one embodiment, the frequency of movement of the carrier is greater than 1 kHz, for example, 1 to 200 kHz, or between 2 kHz and 100 kHz, or between 2 kHz and 50 kHz.

In at least one embodiment, the wavelength of the laser light source is between the mid-infrared range and the visible range, for example, between 380 nm and less than 6000 nm or between 380 nm and 3000 nm.

In at least one embodiment, the spectrometer has one, two, three, four or five optical elements.

In at least one embodiment, a first optical element is arranged immediately behind the laser light source along the path length from the laser output to the photodetector or is the initial optical element along this path length.

In at least one embodiment, an optical element is a first refractive element. In a further embodiment, an optical element is a second or third refractive element.

In at least one embodiment, the at least one optical element is designed as a back reflector arrangement with at least one reflector element or a cross-stack in the path between the laser and the photodetector, wherein the back reflector arrangement is fixedly mounted and thus is not arranged on a movable carrier.

In at least one embodiment, the spectrometer is an absorption spectrometer, for example a laser spectrometer or a diode laser absorption spectrometer.

In at least one embodiment, the evaluation unit comprises a measuring circuit and evaluation electronics that are designed to modulate the frequency of the coherent laser output, and to convert it into an electrical signal on the photodetector, and to record it, wherein the electrical signal is used to determine
a) the concentration of at least one gas to be analyzed and/or
b) the pressure and/or
c) the temperature.

In at least one embodiment, the evaluation unit has a measuring circuit and evaluation electronics that are additionally designed to determine the translational and/or rotational movement instruction, which is transmitted to the controller, which controls the carrier on which the laser and/or the first optical element is mounted, in order to suppress interference signals which arise on the at least one optical element as optical interference due to the superposition of rays of different optical path lengths due to the at least partial reflection on at least one optical surface.

In at least one embodiment, pressure and/or temperature are measured by means of a pressure sensor or a temperature sensor specially built into the spectrometer.

In at least one embodiment, the control signals for moving one or more carriers are converted into a rotary and/or translatory movement by an actuator, wherein the actuator is selected from a piezo actuator, an electromechanical drive, a hydraulic drive and/or a pneumatic drive.

In at least one embodiment, the at least one optical element has an anti-reflective coating.

The invention further relates to an analysis device for measuring the concentration of at least one gas, for example, one, two, three or four gases, wherein the analysis device comprises a spectrometer according to the invention or an embodiment thereof.

The present disclosure also relates a method for suppressing interference signals of a spectrometer, for example an absorption spectrometer, by means of a tunable laser, for example a diode laser, with a spectrometer according to the invention or an embodiment thereof, comprising:
directing a coherent laser beam from a coherent laser light source comprising a tunable diode laser onto a photodetector along a path having a path length;
modulating a frequency of the coherent laser output;
measuring the optical signal on the photodetector, converting the optical signal into an electrical signal, and transmitting the electrical signal of the photodetector to an evaluation unit;
transmitting one or more instructions to a controller electrically connected to the evaluation unit;
changing the path length of the laser beam by oscillatory movement through a translatory and/or rotary movement of a carrier controlled by a controller on which the laser is mounted, and/or on which the first optical element is mounted,
wherein the movement is selected such that interference signals which arise on the at least one optical element due to scattering and/or reflection, are suppressed; and determining the electronic signal of the photodetector.

The invention also relates to the use of the spectrometer according to the invention, or an embodiment thereof, for the analysis of atmospheric gases and/or the gases of a sewage treatment plant.

### BRIEF DESCRIPTION OF THE DRAWING

FIG. 1 is a schematic flow diagram of the operating principle of an embodiment of the invention.

### DETAILED DESCRIPTION

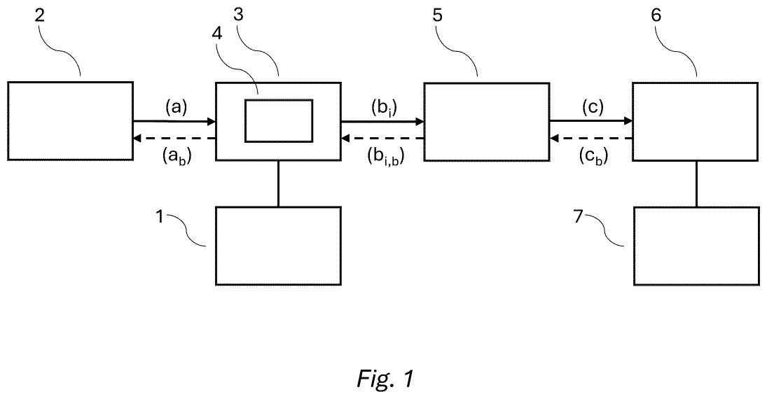

FIG. 1 schematically shows the beam path of a TDL-WMS spectrometer, including the correction of the interference patterns, which are at least partially caused by back reflections. The correction is performed using the first refractive element. The effect is a change in all path length portions, including the portion between the radiation source and the first refractive element.

(a) denotes the first portion between the radiation source (2) and the first optical element (4), mounted on a movable carrier (3) providing translational and/or rotational movement. The movements are controlled by the electronics (1).

(a_{b}) denotes the at least partial reflection of the radiation between the first optical element (4) and the radiation source (2).

(bᵢ) denotes one or more portions of the radiation path.

(b_{i,b}) denotes the at least partial reflection of the radiation between the at least one further optical element (5) and the radiation source (2).

(c) denotes the last portion between the last optical element (5) and the detector (6), in which the at least one gas to analyzed is arranged.

(c_{b}) denotes the at least partial reflection of the radiation between the at least one further refractive element, for example the last refractive element (5) and the radiation source (2).

The evaluation unit (7) is configured to receive the electrical signal from the detector.

The dashed lines show at least partial back reflections in portions a, b and c.

All the embodiments of the inline sensor and of the method described above can be combined with each other in each case, provided that this is technically possible.

1. A spectrometer comprising:
a laser light source configured to generate coherent radiation, including a tunable diode laser with a coherent laser output, wherein the laser light source is configured to modulate the frequency of the coherent laser output;
a photodetector arranged to receive an optical signal from the laser output after traversing a path length;
at least one optical element arranged along the path length between the laser output and the photodetector, wherein the at least one optical element includes at least one optically effective surface; and
an evaluation unit electrically connected to the photodetector and configured to receive an electrical signal from the photodetector, to analyze the electrical signal, and to transmit instructions to a controller electrically connected to the evaluation unit, wherein
the laser light source and/or the at least one optical element is mounted on a movable carrier, wherein the carrier is moved by a drive driven by the controller via control signals, wherein the movement of the carrier is an oscillatory movement with an amplitude and/or frequency and changes the path length of the radiation such that interference signals which arise on the at least one optical element as optical interference due to the superposition of rays of different optical path lengths by the at least partial reflection on at least one optical surface are suppressed, wherein the suppression is effected by interference between the radiation emitted from the light source and the change in the path length of the beam path due to the movement on the movable carrier.

2. The spectrometer according to claim 1, wherein
the movable carrier has a rotator, wherein
the rotator is rotatable by less than 10° continuously or stepwise about the x, y or z axis or any combination thereof and/or includes a translator, wherein
the translator is movable continuously or stepwise along the x, y or z axis or any combination thereof.

3. The spectrometer according to claim 1, wherein the amplitude is a multiple of the laser wavelength.

4. The spectrometer according to claim 1, wherein the movement of the carrier is temporally sinusoidal, sawtooth-shaped, triangular or rectangular.

5. The spectrometer according to claim 1, wherein the frequency of movement of the carrier is greater than 1 KHz.

6. The spectrometer according to claim 1, wherein a wavelength of the laser light source is between the mid-infrared range and the visible range.

7. The spectrometer according to claim 1, wherein the spectrometer includes four optical elements.

8. The spectrometer according to claim 1, wherein the at least one optical element is a first optical element, which is arranged adjacent the laser light source along the path length from the laser output to the photodetector or is an initial optical element along this path length.

9. The spectrometer according to claim 1, wherein the at least one optical element includes a back reflector arrangement with at least one reflector element or a cross-stack in the path length between the laser and the photodetector, wherein the back reflector arrangement is fixedly mounted.

10. The spectrometer according to claim 1, wherein the spectrometer is an absorption spectrometer.

11. The spectrometer according to claim 1, wherein the evaluation unit comprises a measuring circuit and evaluation electronics configured
to modulate the frequency of the coherent laser output and
to convert the optical signal into an electrical signal on the photodetector and
to record the electrical signal, wherein
the electrical signal is used to determine the concentration of at least one gas to be analyzed.

12. The spectrometer according to claim 1, wherein the control signals for moving one or more carriers are converted into a rotary and/or translatory movement by an actuator.

13. The spectrometer according to claim 1, wherein the at least one optical element has an anti-reflective coating.

14. An analysis device for measuring the concentration of at least one gas, wherein the analysis device comprises a spectrometer according to claim 1.

15. A method for suppressing interference signals of a spectrometer according to claim 1, comprising:
directing the coherent laser output from the laser light source onto the photodetector after traversing the path length;
modulating the frequency of the coherent laser output;
measuring the optical signal on the photodetector;
converting the optical signal into the electrical signal;
transmitting the electrical signal of the photodetector to the evaluation unit;
transmitting one or more instructions to the controller electrically connected to the evaluation unit;
changing the path length of the laser beam by oscillatory movement through the translatory and/or rotary movement of a carrier controlled by a controller, on which the laser is mounted or the first optical element is mounted, wherein the movement is adapted such that interference signals, which arise on the at least one optical element due to scattering and/or reflection, are suppressed; and
determining the electrical signal of the photodetector.

16. The spectrometer according to claim 1, wherein the at least one optical element is a refractive or reflective optical element.

17. The spectrometer according to claim 2, wherein the rotator is rotatable by less than 2°.

18. The spectrometer according to claim 1, wherein the amplitude is 2 to 10 times the laser wavelength.

19. The spectrometer according to claim 1, wherein the amplitude is between 0.5 μm and 50 μm.

20. The spectrometer according to claim 1, wherein the frequency of movement of the carrier is between 2 and 50 KHz.

21. The spectrometer according to claim 1, wherein the spectrometer is a tunable diode laser absorption spectrometer.

22. The spectrometer according to claim 12, wherein the actuator is selected from a piezo actuator, an electromechanical drive, a hydraulic drive, and/or a pneumatic drive.

23. The spectrometer according to claim 11, wherein the electrical signal is used to determine a pressure and/or a temperature.

24. The method of claim 15, wherein the concentration of at least one gas is determined.
